(19) United States
(12) Patent Application Publication
(10) Pub. No.: US 2006/0204773 A1
(43) Pub. Date: Sep. 14, 2006

(54) PVC-rubber flooring using rubber sol and method for producing the same

(76) Inventors: Oh-Jeong Kwon, Cheongju-si (KR); Jong-Seok Son, Daejeon (KR)

Correspondence Address: CANTOR COLBURN, LLP, 55 GRIFFIN ROAD SOUTH, BLOOMFIELD, CT, 06002, US

(21) Appl. No.: 11/352,059

(22) Filed: Feb. 10, 2006

(30) Foreign Application Priority Data
Mar. 11, 2005 (KR) 10-2005-0020388

(51) Int. Cl. B32B 25/04; B32B 27/08

(52) U.S. Cl. 428/519; 428/492

(57) ABSTRACT

Disclosed herein is a method for producing a PVC-rubber flooring by a casting process utilizing the sol-gel principle using a rubber sol, which is prepared by milling a liquid or solid rubber in a plasticizer. The rubber sol can be mixed and reacted with a conventional PVC sol. Further disclosed is a PVC-rubber flooring produced by the method. The PVC-rubber flooring has physical properties superior to those of conventional rubber floorings while maintaining the inherent characteristics of the rubber.

### BACKGROUND OF THE INVENTION

This application claims the benefit of the filing date of Korean Patent Application No. 10-2005-0020388 filed on Mar. 11, 2005 in the Korean Intellectual Property Office, the disclosure of which is incorporated herein in its entirety by reference.

### FIELD OF THE INVENTION

The present invention relates to a PVC-rubber flooring using a rubber sol and a method for producing the flooring. More particularly, the present invention relates to a PVC-rubber flooring in which dispersion and reaction of a rubber are achieved using a rubber sol, and a method for producing the PVC-rubber flooring by a casting process which enables mixing and reaction of the rubber sol with a PVC sol.

### DESCRIPTION OF THE RELATED ART

In general, conventional rubber floorings are produced by calender molding process, vulcanization process utilizing vulcanization/crosslinking, or melting process utilizing the interaction between polyvinyl chloride (PVC) and modified rubber.

Rubber floorings made of rubber alone have disadvantages in that complicated production processes and considerable production time are required. These disadvantages become more and more serious by additional vulcanization. To overcome the disadvantages, rubber is mixed with a highly flowable polyvinyl chloride (PVC) resin. However, rubber is not readily swollen by or mixed with plasticizers, unlike PVC, due to its inherent characteristics. Although rubber is successfully mixed with a plasticizer, rubber is poorly compatible with a PVC sol containing the plasticizer, making it difficult to obtain desired physical properties.

Korean Patent Laid-open No. 2003-18670 discloses a floor decorative material which comprises an elastic foam layer containing PVC and a rubber. According to the flooring decorative material, however, since the elastic foam layer is formed by simply mixing the PVC with the rubber, the rubber is substantially incompatible with a PVC sol, as mentioned above.

Korean Patent No. 439313 discloses a flooring with enhanced fixation properties using a modified olefin resin copolymerized with a rubber ingredient. However, the price of the modified olefin resin is high, thus incurring significant increase in the production costs of the flooring. Calendering has also been employed as a process for the production of floorings. Calendering is disadvantageous in the overall line speed and processing efficiency when compared to a casting process for changing a sol to a gel.

### SUMMARY OF THE INVENTION

It is one object of the present invention to provide a PVC-rubber flooring using a rubber sol that can be mixed and reacted with a PVC sol while maintaining the inherent characteristics of the rubber, thereby allowing the PVC-rubber flooring to have physical properties superior to those of conventional rubber floorings.

It is another object of the present invention to provide a method for producing the PVC-rubber flooring by which the line speed can be increased and the processing efficiency can be maximized.

In accordance with one aspect of the present invention for achieving the above objects, there is provided a multilayer PVC-rubber flooring comprising at least one gel layer formed by casting a mixture of a PVC sol and a rubber sol.

The rubber sol used in the present invention is a plasticizer-rubber mixed sol, which is prepared by milling a mixture of a plasticizer and a natural or synthetic rubber having a solubility parameter similar to that of the plasticizer. This milling enables the plasticization and dispersion of the rubber. In the present invention, acrylonitrile-butadiene rubber (NBR), butadiene rubber (BR) or styrene-butadiene rubber (SBR) can be used as the rubber. The rubber sol is highly miscible with the PVC plastic sol.

In addition to the rubber having unreacted groups, the rubber sol contains a peroxide-crosslinking agent and other additives. After the rubber is dispersed in the PVC sol, partial crosslinking of the rubber and gelling of the PVC are achieved by heating so that the rubber binds to the PVC.

The PVC sol used in the present invention contains a PVC resin having a degree of polymerization of 500 to 4,000 and preferably 1,500 to 4,000. The use of the high-molecular weight PVC resin ensures high compatibility with the rubber sol, and can solve the problems of stickiness inherent to the rubber and migration of the plasticizer.

A multilayer PVC-rubber flooring according to one embodiment of the present invention comprises a UV layer, a transparent layer, a printed layer, an upper layer, a base layer, a lower layer, and a bottom sizing layer laminated in this order from the top wherein at least one layer of the layers is formed by gelling a mixture of a PVC sol and a rubber sol by casting.

A multilayer PVC-rubber flooring according to another embodiment of the present invention comprises a UV layer, a transparent layer, a printed layer, an upper layer, a base layer, a lower layer, a bottom sizing layer, and a bottom backing layer laminated in this order from the top wherein at least one layer of the layers is formed by gelling a mixture of a PVC sol and a rubber sol by casting.

In accordance with another aspect of the present invention, there is provided a method for producing a multilayer PVC-rubber flooring by adding a synthetic or natural rubber, a plasticizer, a peroxide-crosslinking agent and other additives, dispersing the mixture by milling to prepare a rubber sol in which the rubber is plasticized and dispersed with the plasticizer, gelling a mixture of the rubber sol and a high-molecular weight PVC sol by a casting process to form at least one gel layer, and laminating the gel layer to constitute the multilayer structure.

The flooring of the present invention is characterized in that the flooring is produced by casting process utilizing the sol-gel principle. Accordingly, the rubber flooring of the present invention is different from rubber floorings produced by vulcanization, rubber floorings produced by using a modified polymer resin copolymerized with a rubber ingredient, and rubber floorings produced by a melting process using a mixture of a rubber and PVC, and rubber floorings produced by a calendering process.

To carry out a sol-gel reaction with the PVC sol, the present inventors have selected a rubber compatible with additives depending on the milling conditions for the preparation of the rubber sol, and have focused on the formulation of PVC and a plasticizer.

As a result, the present inventors have found that the problems of stickiness inherent to a rubber and migration of a plasticizer can be solved by blending a high-molecular weight PVC, a filler and other additives with a rubber-plasticizer sol in which a rubber is dispersed by milling.

By varying the milling processing conditions and suitably selecting the additives, the rubber can be swollen, and as a result, the miscibility between the rubber sol and the PVC sol is improved, enabling the application of a casting process. Accordingly, the PVC-rubber flooring of the present invention can be produced by a casting process which enables mixing and reaction of the rubber sol with the PVC sol.

The line speed can be increased and the processing efficiency can be maximized through the sol-gel principle of PVC employed in the present invention. In addition, since the PVC-rubber flooring is not produced by vulcanization process utilizing vulcanization/crosslinking, it has no inherent sulfur smell of rubber and is advantageous in terms of waste recycling. In addition, due to the reaction of the rubber contained in the PVC sol, the PVC-rubber flooring of the present invention has elasticity and slip properties similar to those of the rubber. Furthermore, the PVC-rubber flooring of present invention has improved physical properties, e.g., mechanical strength and wear resistance.

### BRIEF DESCRIPTION OF THE DRAWINGS

The above and other objects, features and other advantages of the present invention will be more clearly understood from the following detailed description taken in conjunction with the accompanying drawings in which:

FIG. 1 is a cross-sectional view of a PVC-rubber flooring according to one embodiment of the present invention; and

FIG. 2 is a cross-sectional view of a PVC-rubber flooring according to another embodiment of the present invention.

### DESCRIPTION OF THE PREFERRED EMBODIMENTS

The present invention will now be described in more detail with reference to the accompanying drawings.

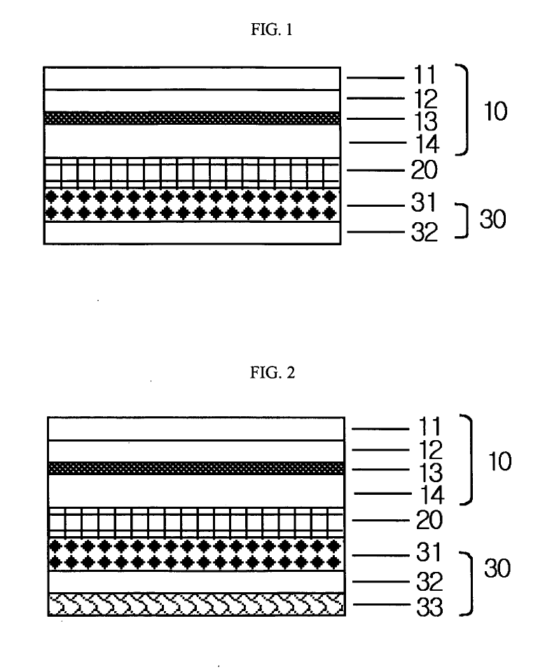

FIG. 1 is a cross-sectional view of a PVC-rubber flooring according to one embodiment of the present invention. The flooring comprises a surface layer 10, a base layer 20, and a bottom layer 30 laminated sequentially from the top. The surface layer 10 includes a UV layer 11, a transparent layer 12, a printed layer 13, and an upper layer 14. The bottom layer 30 includes a lower layer 31 and a bottom sizing layer 32.

FIG. 2 is a cross-sectional view of a PVC-rubber flooring according to another embodiment of the present invention. The flooring further comprises a bottom backing layer 33 laminated under the bottom sizing layer 32 of the bottom layer 30 shown in FIG. 1.

At least one gel layer formed by casting a mixture of a PVC sol and a rubber sol is included in the multilayer floorings according to the embodiments of the present invention. The upper layer 14 and the lower layer 31 may be a foam or non-foam layer.

The PVC-rubber flooring shown in FIG. 1 is produced in accordance with the following procedure.

First, 1˜70% by weight of a rubber, such as NBR, BR or SBR, is dispersed in a plasticizer by milling to prepare a rubber sol. To achieve the plasticization, dispersion and crosslinking of the rubber, additives, such as a peroxide-crosslinking agent, are preferably added.

Specifically, the rubber sol is prepared by milling the rubber and the plasticizer using a 2-bone milling roll at room temperature so that the plasticizer is sufficiently adsorbed to the rubber (first milling) and repeating the first milling (second milling). The plasticizer used during the milling is a mixture of a primary plasticizer, such as dioctyl phthalate (DOP), and a secondary plasticizer, such as diisononyl phthalate (DINP) in an appropriate mixing ratio. In addition, a peroxide-crosslinking agent, such as peroxide, and other additives, such as calcium carbonate particles and sulfur, are added.

The rubber contains unreacted groups, e.g., carboxyl group (—COOH). When the rubber sol is mixed with a PVC sol, the rubber is dispersed in the PVC sol. Upon heating, PVC contained in the PVC sol is fixed to the rubber, and at the same time, the reaction of the rubber is allowed to proceed by the action of the peroxide-crosslinking agent, leading to binding between the rubber and the PVC.

Next, 100 parts by weight of a PVC resin (degree of polymerization: 500˜4,000), 10˜100 parts by weight of the plasticizer, 1˜20 parts by weight of a stabilizer, 1˜100 parts by weight of a pigment, 1˜300 parts by weight of a filler, 1˜200 parts by weight of the rubber sol, and small amounts of other additives are mixed together to prepare a PVC sol. Thereafter, the sol is spread on a base, such as a glass fiber, a vellum paper, an inorganic material or a paper, and gelled at a speed of 5˜60 m/min. at 130˜200° C. for 200 seconds to form a base layer 20. At this time, when the gelling is carried out at a temperature exceeding 200° C., the rubber may be discolored. Accordingly, care should be taken to maintain the gelling temperature within the above range.

Next, an upper layer 14 is formed on the base layer 20. The upper layer 14 may be a foam layer to soften the final flooring or a non-foam layer to harden the final flooring.

The foam layer is formed by mixing 100 parts by weight of a PVC resin (degree of polymerization: 1,000˜4,000), 1˜200 parts by weight of the rubber sol, 110˜100 parts by weight of the plasticizer, 2˜5 parts by weight of azodicarboxylic amide as a foaming agent, 2˜4 parts by weight of a zinc compound as a foaming accelerator, 1˜3 parts by weight of a barium-zinc compound as a foaming stabilizer, 1˜5 parts by weight of titanium oxide as a pigment, 1˜150 parts by weight of calcium bicarbonate as a filler, and 0.1˜1.5 parts by weight of a viscosity-reducing agent as an additive to prepare a sol, coating the sol to a thickness of 0.1˜0.3 mm on the base layer 20 by a known technique, and gelling the coated sol at a speed of 10˜15 m/min. in an oven at 150˜210° C. for 1˜2 minutes.

The non-foam layer is formed by mixing 100 parts by weight of a PVC resin (degree of polymerization: 1,000˜4,000), 1˜200 parts by weight of the rubber sol, 10˜100 parts by weight of the plasticizer, 2˜7 parts by weight of a barium-zinc compound as a heat stabilizer, and 1˜5 parts by weight of an epoxy resin (e.g., soybean oil) for reinforcing long-term low-temperature resistance as an additive to prepare a sol, coating the sol to a thickness of 0.1˜0.7 mm on the base layer 20 by a known technique, and gelling the coated sol at a speed of 10˜50 m/min. in an oven at 130˜210° C. for 30˜180 seconds.

Next, a printed layer 13 is formed by forming a pattern on the upper layer 14 using gravure, offset ink, rotary screen, or transfer paper.

Next, a transparent layer 12 is formed on the printed layer 13. Specifically, the transparent layer 12 is formed by mixing 100 parts by weight of a PVC resin (degree of polymerization: 500˜4,000), 1˜200 parts by weight of the rubber sol, 10˜120 parts by weight of the plasticizer, 1˜20 parts by weight of a stabilizer, and small amounts of additives to prepare a sol, coating the sol to a thickness of 0.1˜0.7 mm on the printed layer 13, and gelling the coated sol at a speed of 10˜50 m/min. at 130˜230° C. for 20˜150 seconds.

Next, a UV layer 11 is formed on the transparent layer 12 by a known technique.

The transparent layer 12 may be omitted, if required.

Next, a lower layer 31 is formed under the base layer 20. The lower layer 31 may be a foam or non-foam layer.

The foam layer is formed by mixing 100 parts by weight of a PVC resin (degree of polymerization: 500˜4,000), 1˜200 parts by weight of the rubber sol, 10˜120 parts by weight of the plasticizer, 1˜20 parts by weight of a pigment, 1˜20 parts by weight of a stabilizer, 1˜20 parts by weight of a foaming agent, 1˜250 parts by weight of a filler, and small amounts of other additives to prepare a sol, coating the sol to a thickness of 0.2˜0.7 mm, and foaming the coated sol at a speed of 5˜50 m/min. at 170˜250° C. for 30˜180 seconds.

The non-foam layer is formed by mixing 100 parts by weight of a PVC resin (degree of polymerization: 500˜4,000), 1˜200 parts by weight of the rubber sol, 10˜120 parts by weight of the plasticizer, 1˜20 parts by weight of a pigment, 1˜20 parts by weight of a stabilizer, 1˜250 parts by weight of a filler, and small amounts of other additives to prepare a sol, coating the sol to a thickness of 0.1˜2.0 mm, and gelling the coated sol at a speed of 5˜50 m/min. at 170˜250° C. for 30˜180 seconds.

Next, a bottom sizing layer 32 is formed under the lower layer 21. The bottom sizing layer 32 may be omitted, if required.

A backing material, such as a woven fabric or non-woven fabric, may be further attached under the bottom sizing layer 32 to produce the PVC-rubber flooring shown in FIG. 2.

### EXAMPLE 1

The respective layers other than the printed layer and the UV layer of the flooring shown in FIG. 1 were formed using the major ingredients and their content indicated in Table 1. The rubber sol was prepared by dispersing an NBR rubber in 50% by weight of the plasticizer (DOP or DINP) by milling. Specifically, the rubber sol was prepared by milling the rubber and the plasticizer using a 2-bone milling roll (first milling) and repeating the first milling (second milling). A peroxide, calcium carbonate particles, sulfur and other additives were added to the rubber sol.

TABLE 1

| Ingredients | Content (parts by weight) |
|---|---|
| Polyvinyl chloride resin | 100 |
| (Degree of polymerization 3,000) | |
| Rubber sol | 70 |
| Plasticizer (DOP, DINP) | 15 |
| Filler (Calcium carbonate) | 40 |

### COMPARATIVE EXAMPLES

A conventional rubber flooring (Comparative Example 1) was produced by adding sulfur to a rubber powder, such as a SBR or NBR powder, as a base resin, and vulcanizing the mixture under a particular pressure at 150˜200° C. in accordance with the composition indicated in Table 2.

TABLE 2

| Ingredients | Content (parts by weight) |
|---|---|
| Styrene-butadiene rubber (SBR) | 30 |
| Sulfur (S) | 2 |
| Filler (Calcium carbonate, etc.) | 70 |

A conventional PVC flooring was produced in accordance with the composition indicated in Table 3. Calcium carbonate, a stabilizer and other additives were added to satisfy the basic physical properties.

TABLE 3

| Ingredients | Content (parts by weight) |
|---|---|
| Polyvinyl chloride resin | 100 |
| Plasticizer (DOP, BBP, etc) | 40 |
| Filler | 80 |

### TEST EXAMPLES

The physical properties of the flooring produced in Example 1 were compared with those of the floorings produced in Comparative Examples 1 and 2. The results are shown in Table 4.

TABLE 4

| Physical | | | | Comparative | Comparative |
|---|---|---|---|---|---|
| properties | Specification | Conditions | Example 1 | Example 1 | Example 2 |
| Cleaner | — | Stability against | Good | Good | Good |
| stability | | neutral cleaner | | | |
| Hardness | ASTM | ≧85 | 86 | 90 | 87 |
| | D2240 | | | | |
| Modulus at | ASTM | ≧2.07 Mpa | 2.1 | 2.5 | 1.5 |
| 10% Elongation | D410 | | | | |
| Static Load Limit | ASTM | ≦0.076 mm | 0.05 | 0.04 | 0.09 |
| | F970 | | | | |
| Chemical | ASTM | Resistance against | Good | Discoloration | Good |
| resistance | F925 | eleven chemicals | | of oily | |
| | | | | ingredients | |
| Heat | ASTM | 70° C., 7 days, | 5.4 | 8.2 | 5.2 |
| resistance | F1514 | Color change | | | |
| | | ΔE ≦ 8.0 | | | |
| Light | ASTM | Xenon-arc radiant | 6.2 | 8.5 | 5.6 |
| resistance | F1515 | energy source, | | | |
| | | 300 hrs, ΔE ≦ 8.0 | | | |
| Wear | ASTM | ≦1 g | 0.15 | 2.21 | 0.10 |
| resistance | D4060 | | (0.22) | (0.85) | (0.20) |
| | (EN660) | | | | |
| Slip | JIS A1454 | 0.4-0.6 | 0.49-0.52 | 0.49-0.55 | 0.40-0.48 |
| properties | | | | | |
| Non-slip | D2240 | | 0.52 | 0.53 | 0.47 |
| Cold resistance | — | | −35° C. | −23° C. | −4° C. |

As can be seen from the data shown in Table 4, the PVC-rubber flooring (Example 1) of the present invention has mechanical strength, wear resistance and discoloration properties comparable or superior to those of the conventional rubber flooring (Comparative Example 1) and the conventional PVC flooring (Comparative Example 2).

Further, the overall line speed of the flooring according to the present invention produced by a casting process is between 20 and 30 m/min., whereas that of the conventional floorings produced by calendering is below 10 m/min. Accordingly, according to the method of the present invention, the line speed can be increased and the processing efficiency can be maximized.

As apparent from the above description, the PVC-rubber flooring of the present invention can be produced by a casting process utilizing the sol-gel principle using a rubber sol, which can be mixed and reacted with a conventional PVC sol. As a result, the PVC-rubber flooring of the present invention has physical properties superior to those of conventional rubber floorings while maintaining the inherent characteristics of the rubber.

Since the method of the present invention utilizes the sol-gel principle of PVC, the line speed can be increased and the processing efficiency can be maximized. In addition, since the PVC-rubber flooring of the present invention is not produced in a vulcanization/crosslinking manner, it has no inherent sulfur smell of rubber and is advantageous in terms of waste recycling. Furthermore, due to the reaction of a rubber contained in a PVC sol, the PVC-rubber flooring of the present invention has elasticity and slip properties similar to those of a rubber. Moreover, the PVC-rubber flooring of present invention has improved physical properties, e.g., mechanical strength and wear resistance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A multilayer PVC-rubber flooring comprising at least one gel layer formed by gelling a mixture of a PVC sol and a rubber sol.

2. The PVC-rubber flooring according to claim 1, wherein the rubber sol is a dispersion of a rubber in a plasticizer.

3. The PVC-rubber flooring according to claim 2, wherein the rubber is at least one selected from acrylonitrile-butadiene rubber (NBR), butadiene rubber (BR) and styrene-butadiene rubber (SBR).

4. The PVC-rubber flooring according to claim 2, wherein the rubber sol contains a peroxide-crosslinking agent.

5. The PVC-rubber flooring according to claim 4, wherein the rubber of the rubber sol is dispersed in the PVC sol and partially crosslinked with gelling of the PVC by heating so that the rubber binds to the PVC.

6. The PVC-rubber flooring according to claim 1, wherein the PVC sol contains a PVC resin having a degree of polymerization of 500 to 4,000.

7. The PVC-rubber flooring according to claim 1, wherein the multilayer PVC-rubber flooring comprises a UV layer, a transparent layer, a printed layer, an upper layer, a base layer, a lower layer and a bottom sizing layer laminated in this order from the top.

8. The PVC-rubber flooring according to claim 7, further comprising a bottom backing layer laminated under the bottom sizing layer.

9. The PVC-rubber flooring according to claim 7, wherein at least one layer of the transparent layer, the upper layer, the base layer, the lower layer and the bottom sizing layer is formed by gelling the mixture of the PVC sol and the rubber sol.

10. A method for producing a PVC-rubber flooring, comprising the steps of:
plasticizing and dispersing a rubber with a plasticizer to prepare a rubber sol;
mixing the rubber sol with a PVC sol; and
gelling the mixed sol by a casting process to form a gel layer and laminating at least one of the gel layer to constitute a multilayer structure.

11. The method according to claim 10, wherein the rubber sol is prepared by dispersing the rubber with the plasticizer by milling.

12. The method according to claim 11, wherein the rubber sol is prepared by a first milling and a second milling using a 2-bone milling roll.
